(19) United States
(12) Patent Application Publication
(10) Pub. No.: US 2026/0079065 A1
(43) Pub. Date: Mar. 19, 2026

(54) LEAK DETECTION CHASSIS BASE SYSTEM WITH A CONDUCTIVE MATERIAL

(71) Applicant: DELL PRODUCTS L.P., Round Rock, TX (US)

(72) Inventors: Patrick Illingworth, Austin, TX (US); Sandor Farkas, Round Rock, TX (US)

(21) Appl. No.: 18/887,220

(22) Filed: Sep. 17, 2024

(51) Int. Cl. G01M 3/16; G06F 1/20

(52) U.S. Cl. CPC G01M 3/16; G06F 1/20

(57) ABSTRACT

An information handling system includes a leak detection sensor that has an insulator with a first surface and a second surface. The information handling system also includes a first conductive ink formed to a first conductive pattern on the first surface and a second conductive ink formed to a second conductive pattern on the second surface. In addition, the information handling system includes a processor coupled to the leak detection sensor, the processor is configured to measure resistance change with the first conductive ink and the second conductive ink and in response to a determination that the resistance change is below a threshold, the processor transmit a signal indicating that a leak is detected.

### FIELD OF THE DISCLOSURE

The present disclosure generally relates to information handling systems, and more particularly relates to a leak detection chassis base system with conductive material.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a leak detection sensor that has an insulator with a first surface and a second surface. The information handling system also includes a first conductive ink arranged in a first conductive pattern on the first surface and a second conductive ink arranged in a second conductive pattern on the second surface. In addition, the information handling system includes a processor coupled to the leak detection sensor. The processor may measure resistance change between the first conductive ink and the second conductive ink. In response to a determination that the resistance change is below a threshold, the processor may transmit a signal indicating that a leak is detected.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system that includes a leak detection chassis base system with a conductive material, according to an embodiment of the present disclosure;

FIG. 2 is an exploded view of a chassis and a leak detector with a conductive material, according to an embodiment of the present disclosure;

FIG. 3 is a view of a chassis and a leak detector with a conductive material, according to an embodiment of the present disclosure;

FIG. 4 is a view of a leak detector, according to an embodiment of the present disclosure;

FIGS. 5A and 5B are cross-section views of a leak detector assembly, according to an embodiment of the present disclosure;

FIG. 6 is a view of a leak detector, according to an embodiment of the present disclosure.

FIGS. 7A and 7B are cross-section views of a leak detector assembly, according to an embodiment of the present disclosure;

FIGS. 8A and 8B are cross-section views of a leak detector assembly, according to an embodiment of the present disclosure;

FIG. 9 is a flowchart of a method for a leak detection chassis base system with conductive material, according to an embodiment of the present disclosure; and

FIG. 10 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

As processors, graphics cards, random access memory (RAM), and other components of an information handling system increased in clock speed and power consumption, the amount of heat produced by such components as a side-effect of normal operation has also increased. Often, the temperature of these components needs to be kept at a reasonable range to prevent overheating, instability, malfunction, and damage leading to a shortened component lifespan. Accordingly, air movers, such as cooling fans and blowers have been used in information handling systems for cooling.

To control the temperature of the components, an air mover may direct air over one or more heatsinks thermally coupled to individual components. Traditional approaches to cooling equipment may include a “passive” cooling system that serves to reject the heat of a component to air driven by one or more system-level air movers for cooling multiple components of an information handling system in addition to the peripheral component. Another traditional approach may include an “active” cooling system that uses liquid cooling in which a heat-exchanging cold plate is thermally coupled to the component and a chilled fluid is passed through the conduits internal to the cold plate to remove the heat from the component.

Because liquid cooling systems often utilize water, a water-based solution, or other electrically conductive fluid, leaks from a liquid cooling system may present a danger to electrical and electronic components of the information handling system. Currently available leak detection designs typically utilize a leak detection rope that is installed in various locations of a computer chassis. However, the leak detection rope typically cannot detect small leaks. In addition, the leak detection rope can only detect leaks in certain areas, such as where it was installed. As such, the leak detection rope provides insufficient leak area coverage. Thus, there is a need for improvement in this leak detection design. Accordingly, the present disclosure provides a system and method for leak detection chassis base system with conductive material with better coverage and the ability to detect small leaks.

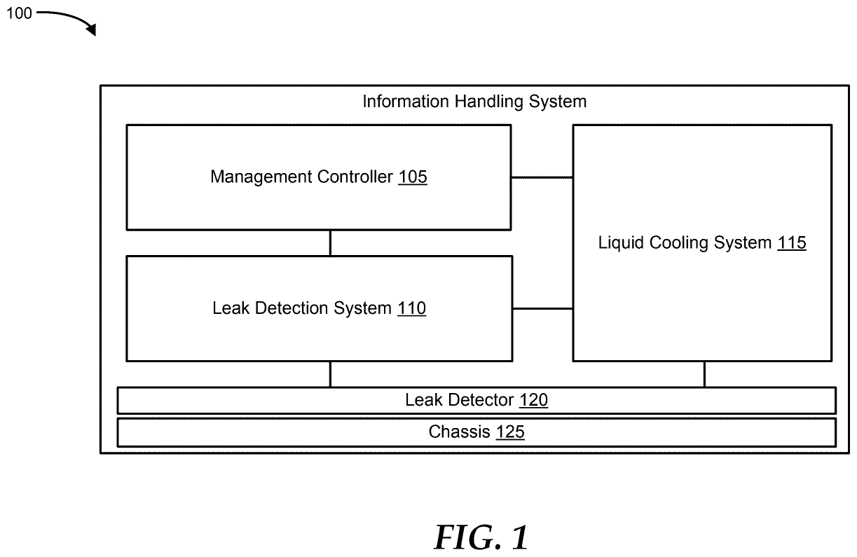

FIG. 1 illustrates a portion of an information handling system 100 that includes a leak detection chassis base system with a conductive ink sensor, according to an embodiment of the present disclosure. Information handling system 100 includes a management controller 105, a leak detection system 110, a liquid cooling system 115, a leak detector 120, and a chassis 125. Leak detection system 110 may include one or two analog-to-digital converts and a microcontroller unit (MCU). Leak detection system 110 may also include a resistor, a capacitor, and an impedance device. Leak detector 120, also referred to as a leak detection sensor or simply a leak sensor, may include common reference interconnects and a set of traces connected to the reference interconnects. The resistor, capacitor, and/or impedance device may be connected to the traces.

Leak detection system 110 may be connected to management controller 105, liquid cooling system 115, and leak detector 120. However, any variety of connections between leak detection system 110 and other components of information handling system 100 are envisioned as falling within the scope of the present disclosure. In addition, connections between the components may be omitted for descriptive clarity. Further, although leak detection system 110 is shown separate from liquid cooling system 115, leak detection system 110 may be part of liquid cooling system 115.

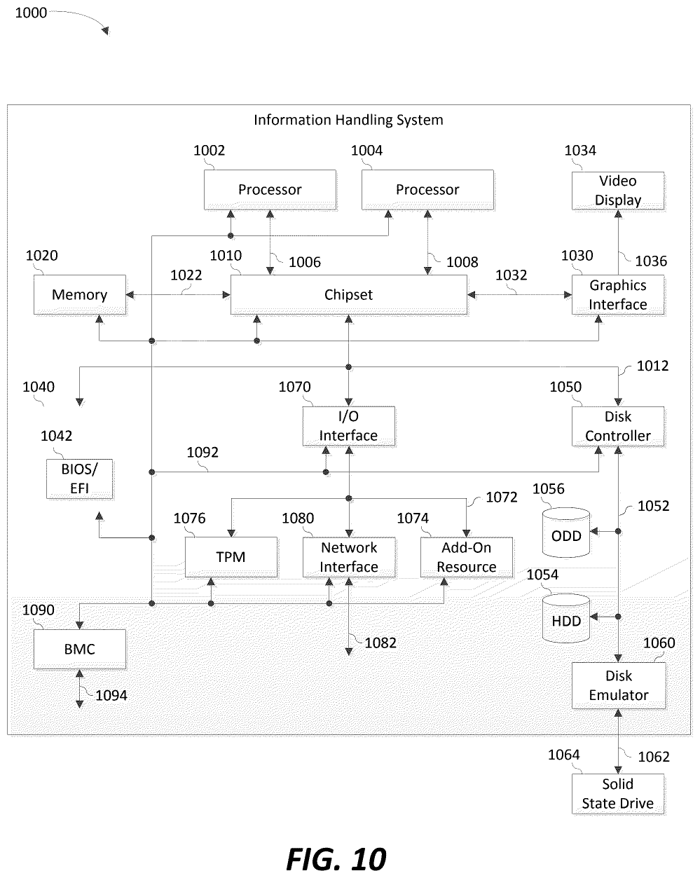

Information handling system 100, which is similar to information handling system 1000 of FIG. 10 may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling system 100 may also be a portable information handling system that may include a laptop, a notebook, a smartphone, a tablet, or a personal digital assistant, among others.

Information handling system 100 includes one or more components that generate heat within its enclosure. For example, information handling system 100 includes one or more processors, chipset components, graphic processing units, memory devices, storage devices, etc. that represent a thermal load of information handling system 100. The enclosure of information handling system 100 includes a top cover and a bottom chassis at its base. However, the enclosure may also include a side chassis.

Liquid cooling system 115 may be configured to cool, remove, and/or manage the heat generated within information handling system 100. For example, liquid cooling system 115 may include a cold plate to provide cooling to one or more components of information handling system 100. Liquid coolant may be circulated by liquid cooling system 115 in a closed loop inside electronic enclosures which include fittings, joints, and hoses to complete the loop. These parts can develop leaks over time due to vibration, thermal cycles, or aging. A leak would result in water in information handling system 100 that can cause corrosion or damage to circuitry. Typically, liquid coolant that leaks may flow in a direction of a gravitational force, such as towards a bottom chassis.

Leak detector 120 may be configured to detect the presence or absence of moisture at the surface of chassis 125, wherein chassis 125 may be disposed at a bottom enclosure of information handling system 100. However, chassis 125 may not be limited to the bottom chassis of the information handling system. For example, chassis 125 may be a side chassis or a top chassis. For example, a leak detector assembly that includes chassis 125 and leak detector 120 may be utilized to catch liquid leaking to prevent the cooling liquid from damaging other components of the information handling system.

Leak detector 120 may include an insulating material with a first surface that includes conductors or electrodes from a conductive material, such as a conductive ink or paint, arranged in a pattern. The pattern may include multiple redundant connections that may function even when there are scratches or cuts in the pattern. In one embodiment, the conductive material may include a conductive polymer ink, conductive polymer paint, or similar, which can be carbon or silver-based and can be impregnated with rubber. This allows the conductive material to be flexible and prevents cracks from forming during the vacuum-forming process. In addition, the insulating material may also include a second surface that is physically coupled to a surface of chassis 125.

The conductive material may have an impedance, such as a resistive or capacitive impedance which may vary based on whether moisture is present on the conductive material. For example, in the presence of liquid, the impedance across the conductive material decreases. Accordingly, leak detector 120 may detect the leak in response to an electrical change between two sections of the conductive material, such as a change in resistance or capacitance values. For example, a resistance value between the two sections of the conductive material may be lower when the conductive material is exposed to liquid. In another example, the resistance value between two sides of the leak detector may be lower when its electrodes are exposed to liquid. Similarly, the capacitance value of the electrodes or traces of the leak detector may be lower when the conductive material is exposed to liquid.

The exposed electrically conductive material also functions as traces. System resistance between two isolated adjacent traces typically have an air gap. When liquid spills on the air gap, the isolation is compromised. The system resistance may decrease in the presence of increased moisture. For example, the liquid coolant may form an electrically conductive solution that may conduct electricity among or between the conductive materials, which may cause the conductive material to short. The electrical resistance may also increase in the presence of decreased moisture on the conductive material. An initial measurement of the electrical resistance associated with the conductive material may be determined during manufacture prior to assembly of information handling system 100. This may be used to determine whether there is a change in the resistance and/or capacitance of the conductive material.

The pattern of conductive material may act as a moisture sensor which includes a differential trace element that is exposed to leaking liquid coolant. One trace of each pair of the differential trace element may be connected to a reference potential, such as a ground voltage, so voltages can be measured with single-ended measurements from an MCU. Both pairs are driven from the MCU through a resistance-capacitance low-pass filter and a resistor, forming a voltage divider with the sensor. Water is slightly conductive, so wet sections of the conductive pattern or traces will have lower impedance.

Leak detection system 110 may include any system, device, or apparatus configured to detect changes in electrical resistance and/or capacitance of conductive material in leak detector 120, wherein the change in the electrical resistance or capacitance may be indicative of the presence or absence of moisture in leak detector 120. In one example, leak detection system 110 may monitor the electrical value of the conductive material. In case of a leak, the conductive material which acts as a sensor provides unbalanced output signals, and leak detection system 110 may detect a difference in amplitudes of the signal.

Leak detection system 110 may determine or calculate a change in an electrical value, such as a resistance or capacitance value, from a previous value. Based on the change in the resistance or capacitance value, leak detection system 110 may determine that the liquid coolant has leaked into the chassis. As such, leak detection system 110 may notify management controller 105, which is similar to a baseboard management controller (BMC) 1090 of FIG. 10, of the presence or absence of moisture at leak detector 120 based on the changes in the electrical resistance and/or capacitance.

In a particular example, two analog-to-digital converters may sample the voltage on the traces. An MCU firmware may be executed by the leak detection system 110 to monitor the change of peak voltages that correlate to impedance. The MCU compares readings and asserts an alert if there is a leak. Accordingly, leak detection system 110 may act as a single controller to drive monitoring and/or measurement of resistance and/or capacitance changes of one or more leak detectors in information handling system 100.

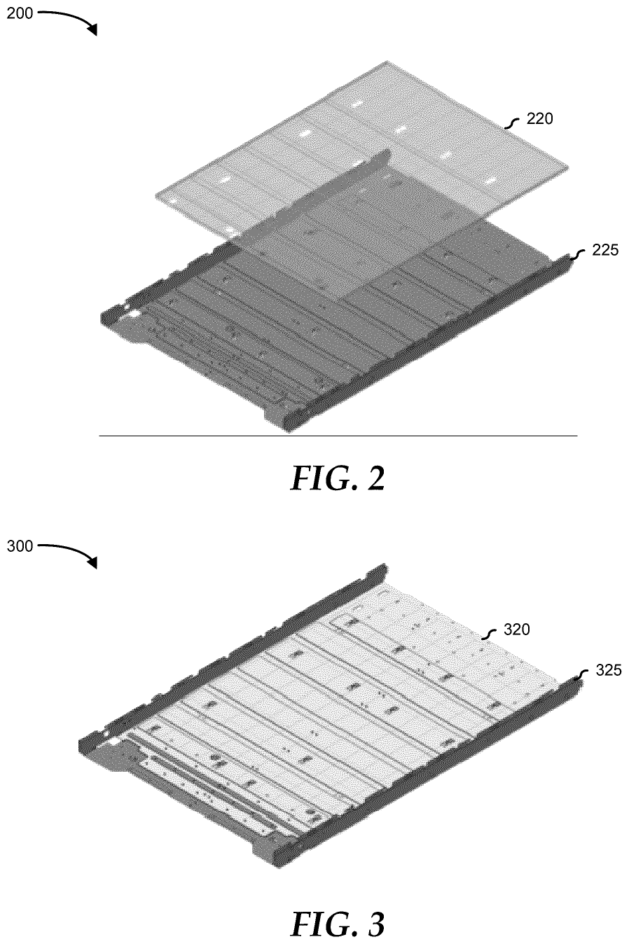

FIG. 2 shows an exploded view of a portion of a leak detector assembly 200, according to an embodiment of the present disclosure. Leak detector assembly 200 includes a chassis 225 and a leak detector 220. Chassis 225 may be similar to chassis 125 of FIG. 1 while leak detector 220 may be similar to leak detector 120 of FIG. 1. In one embodiment, chassis 225 may have a tray structure to trap leaks. Leak detector 220 may be a specially designed thermal/vacuum-formed thin and flexible film insulator. In particular, leak detector 220 may include one or two thin film polymer substrates which by using a thermal/vacuum process are laterally formed on a surface of chassis 225.

Leak detector 220 may include a conductive material, such as a conductive ink printed on a first surface or the top surface of leak detector 220 according to a specific pattern. A second surface or bottom surface of leak detector 220 may be secured to a surface of chassis 225. For example, the second or bottom surface of leak detector 220 may be attached to chassis 225 by a suitable adhesive or any other suitable means of mechanical coupling. Because leak detector 220 is vacuum formed, leak detector 220 may be formed to an arbitrary shape or scale up or down to a specific size providing coverage of the surface of chassis 225.

FIG. 3 shows a perspective view of a portion of a leak detector assembly 300, according to an embodiment of the present disclosure. Leak detector assembly 300 includes a chassis 325 and a leak detector 320. Chassis 325 may be similar to chassis 125 of FIG. 1 while leak detector 320 may be similar to leak detector 120 of FIG. 1. In addition, similar to chassis 225 of FIG. 1, chassis 325 may include a tray structure. Leak detector 320 may be a specially designed sprayed-on layer of insulator material that is deposited on the surface of chassis 325. In one example, the insulator material may be a polymer or acrylic insulator. During the deposition of the insulator material, a conductive pattern may be printed on a first surface or top surface of leak detector 320. A second surface or bottom surface of leak detector 320 may be irremovably secured to a surface of chassis 325. Because leak detector 320 is sprayed on or deposited to chassis 325, leak detector 220 may be formed to an arbitrary shape or scale up or down to a specific size providing coverage of the surface of chassis 325.

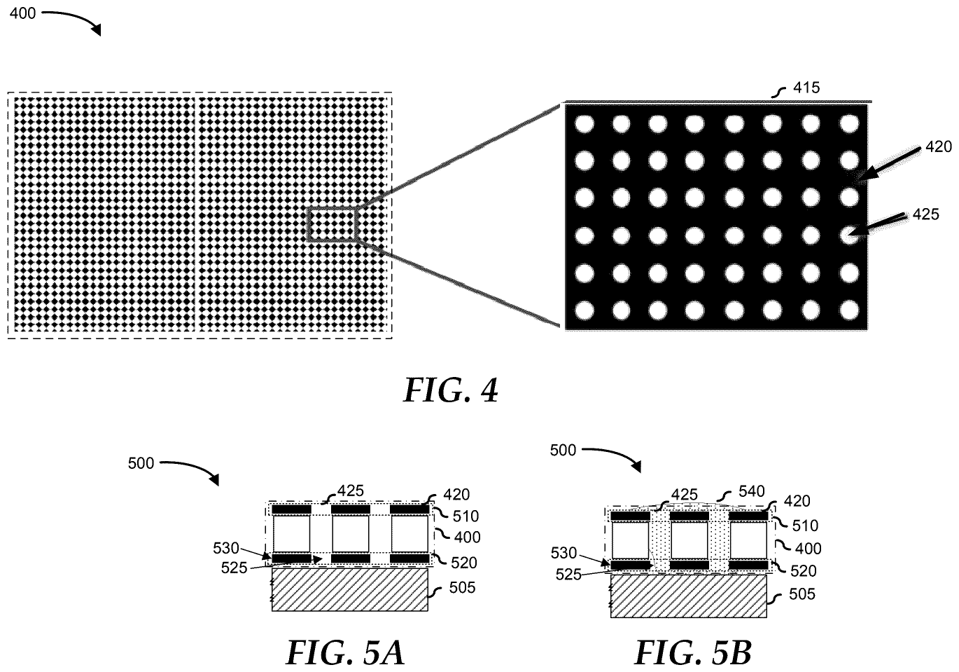

FIG. 4 shows a portion of a leak detector 400, according to an embodiment of the present disclosure. Leak detector 400 may be used to detect for changes in resistance associated with a leak in the information handling system. Leak detector 400 may have through holes, such as hole 425 arranged in a grid at equidistant intervals with a gap between adjacent holes as shown in a section 415 of leak detector 400. The gap may have a conductive material, such as conductive material 420 deposited on both sides of the insulator according to a pattern without clogging the holes or perforation. The pattern can form a conductive path, wherein an electric current can pass through creating a conductor. Afterward, the insulator material may be vacuum-formed to fit a desired area, such as a top, side, or bottom chassis. When there is a leak of the liquid coolant, the liquid coolant may wick into the holes or the perforation. This may provide a conductive path along the conductive material between the two sides of the insulator material.

If there is a change in the resistance, then it may indicate that there is a leak. The change in resistance may be determined and compared with a threshold. For example, resistance between the two sides of leak detector 400 may be monitored. If the change in the resistance is below a particular threshold, then a leak may be detected. The threshold for determining whether the change is slight or large may be pre-determined during the manufacture of the information handling system.

FIG. 5A illustrates a cross-section view of a portion of leak detector assembly 500, according to an embodiment of the present disclosure. Leak detector assembly 500 includes a portion of a leak detector 400 and a portion of chassis 505. Leak detector 400 includes a first side 510 and a second side 520, also referred to as a first surface and a second surface, respectively. A grid of through holes goes from first side 510 through second side 520. In addition, a conductive material may be deposited between the holes according to a pattern on both sides or surfaces of leak detector 400, wherein the pattern of the conductive material on first side 510 may be the same or different from the second side 520. For example, first side 510 includes a hole 425 and conductive material 420 while second side 520 includes a hole 525 and conductive material 530. Resistance between conductive material 420 and 530 may be measured periodically to determine when there is a change in the resistance.

In this example, leak detector 400 may include a single sheet of insulating material. Accordingly, first side 510 and second side 520 may be two sides of the single sheet. However, in another embodiment, leak detector 400 may include two sheets of insulating material. Accordingly, in one embodiment, first side 510 may be a first surface of a first sheet and second side 520 may be a second surface of a second sheet. FIG. 5A will be understood to represent a condition where there is no leak.

FIG. 5B illustrates a condition where a liquid cooling system developed a leak 540 disposed adjacent to hole 425 and conductive material 420 of leak detector 400. In this case, a leak detector and a leak detection system as described above may operate to detect leak 540. In this example, leak 540 may create a conductive path between conductive material 420 and conductive material 530 allowing for electric current to flow. This may result in a change of resistance between conductive materials 420 and 530. To detect the change in the resistance, the resistance may be measured at conductive materials between first side 510 and second side 520 by the leak detection system.

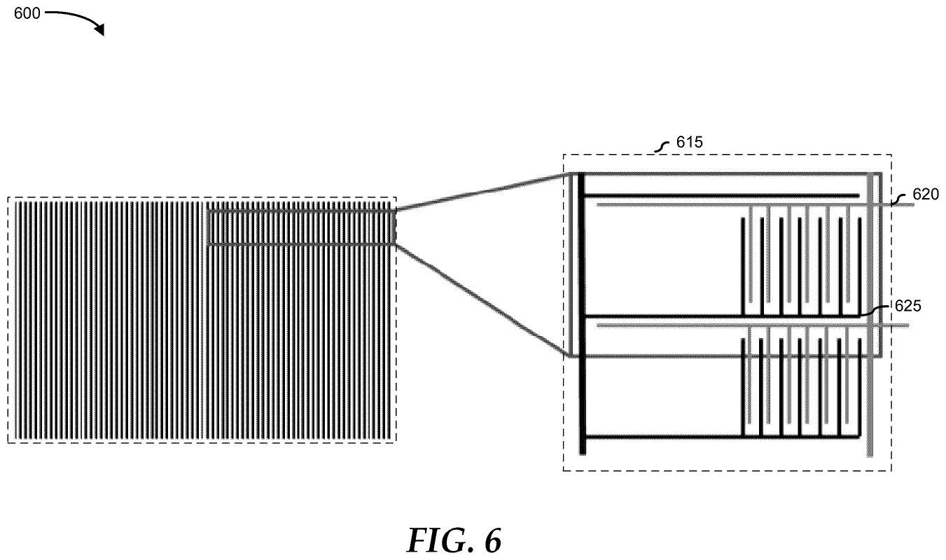

FIG. 6 shows a portion of a leak detector 600 for a leak detection system, according to an embodiment of the present disclosure. The traces may be utilized as sensing traces to detect changes in resistance or capacitance associated with a leak in an information handling system. In a particular example, leak detector 600 which includes a first common reference interconnect 620 and a second common reference interconnect 625 as shown in a section 615 of leak detector 600. Each of the common reference interconnects includes a set of traces that are interdigitated in opposition to each other. The traces may be equidistant from each other. The common reference interconnects and traces may be instantiated on an upper surface of leak detector 600 as conductive traces using a flexible conductive material.

Resistance or capacitance changes of leak detector 600 may be monitored individually and processed differentially. If there is a change in the resistance or capacitance of leak detector 600, then it may indicate a leak in the information handling system. The threshold for determining the change may be pre-determined during the manufacture of the information handling system.

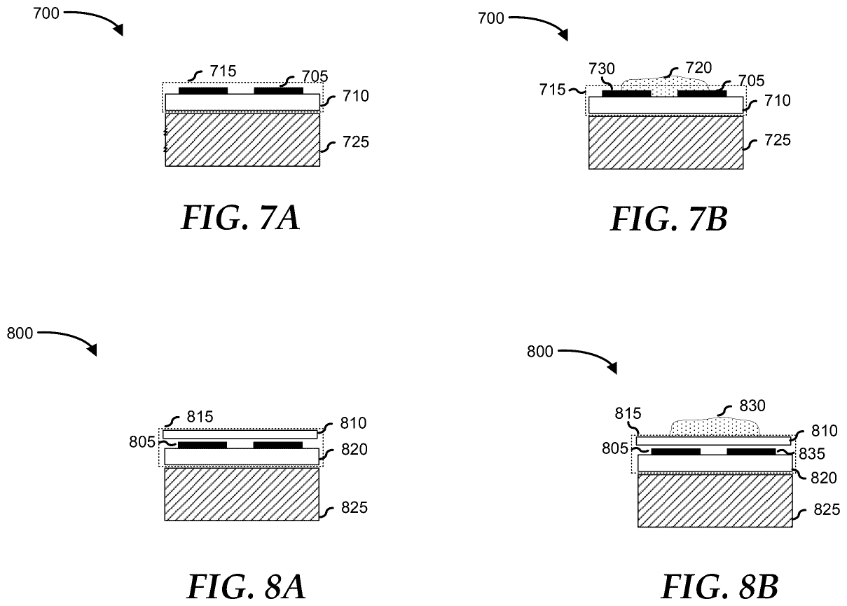

FIG. 7A illustrates a cross-section view of a portion of leak detector assembly 700, according to an embodiment of the present disclosure. Leak detector assembly 700 includes a portion of a leak detector 715 and a portion of chassis 725. Leak detector 715, which is similar to leak detector 600 of FIG. 6, includes an insulating layer and traces, such as an insulator 710 and a trace 705 respectively. FIG. 7A will be understood to represent a condition where there is no leak of liquid coolant.

FIG. 7B illustrates a condition where a liquid cooling system developed a leak 720 that is disposed around trace 705 and insulator 710. In this case, a leak detector and a leak detection system as described above may operate to detect leak 720. Further, leak 720, which may be a liquid coolant leak, may create a conductive path between two traces, such as trace 705 and a trace 730 allowing for electric current to flow. The traces, also referred to as conductors, may be from a conductive material, such as a conductive ink or conductive paint. This may result in a change of resistance between traces 705 and 730.

FIG. 8A illustrates a cross-section view of a portion of leak detector assembly 800, according to an embodiment of the present disclosure. Leak detector assembly 800 includes a leak detector 815 and a chassis 825. Leak detector 815, which is similar to a portion of leak detector 600 of FIG. 6, includes two insulating layers and traces, such as an insulator 810, a trace 805, and an insulator 820. The traces may be from a conductive material, such as a conductive ink or paint. Insulator 820 may be a layer of sprayed-on paint on chassis 825. Insulator 810 may be a layer of sprayed-on insulating paint on trace 805, such that trace 805 is between two insulating layers. FIG. 8A will be understood to represent a condition where there is no leak of liquid coolant.

FIG. 8B illustrates a condition where a liquid cooling system developed a leak 830 that is disposed around insulator 810, trace 805, and a trace 835. Insulator 810 may prevent leak 830 from direct contact with traces 805 and 835. This may also remove accidental shorting between the traces and minimize dust issues. In this case, a leak detector and a leak detection system as described above may operate to detect leak 830.

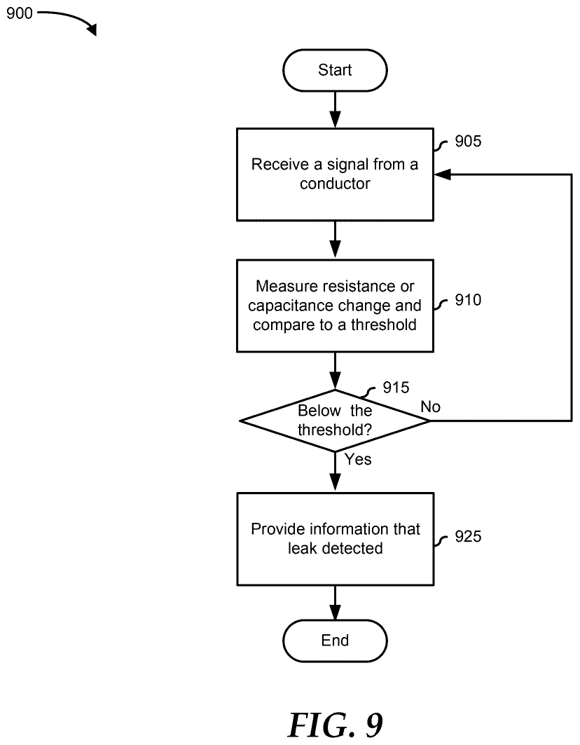

FIG. 9 illustrates a flowchart of a method 900 for a leak detection chassis base system with a conductive ink sensor, according to an embodiment of the present disclosure. Method 900 may be performed by any suitable component of information handling system 100 of FIG. 1 including, but not limited to, leak detection system 110 and leak detector 120 of FIG. 1. While embodiments of the present disclosure are described in terms of the components of information handling system 100 of FIG. 1, it should be recognized that other components may be utilized to perform the described method. One of skill in the art will appreciate that this flowchart explains a typical example, which can be extended to applications or services in practice.

Method 900 typically starts at a block 905 where a leak detection system monitors a leak detector for moisture. At this point, a signal from a leak detector is received. The method proceeds to block 910 where a leak detection system may measure resistance or capacitance change at the leak detector. The measured resistance or capacitance change may be compared to a threshold. The threshold may be determined during the manufacture of the leak detector and/or information handling system. In addition, an initial resistance or capacitance value prior to the leak may be known. The initial resistance or capacitance value along with other data, such as a threshold resistance or capacitance value, may be stored in a non-volatile memory accessible by the leak detection system. Determining the change in the resistance value may include determining an amount of current that flows through the conductive material or traces.

The method proceeds to decision block 915 where the leak detection system may determine whether the resistance or capacitance is below the threshold. If the resistance or capacitance change is below the threshold, then the “YES” branch is taken, and the method proceeds to block 925. If the resistance or capacitance change is not below the threshold, then the “NO” branch is taken, and the method proceeds to block 905. At block 925, the leak detection system may provide information to one or more components, such as a management controller that a leak has been detected. In one or more embodiments, the information that indicates the leak of the liquid coolant may be provided to a network, another information handling system, display device, report, user, etc. Afterwards, the method ends.

FIG. 10 illustrates an embodiment of an information handling system 1000 including processors 1002 and 1004, a chipset 1010, a memory 1020, a graphics adapter 1030 connected to a video display 1034, a non-volatile RAM (NVRAM) 1040 that includes BIOS/EFI module 1042, a disk controller 1050, a hard disk drive (HDD) 1054, an optical disk drive (ODD) 1056, a disk emulator 1060 connected to a solid-state drive (SSD) 1064, an input/output (I/O) interface 1070 connected to an add-on resource 1074 and a trusted platform module (TPM) 1076, a network interface 1080, and BMC 1090. Processor 1002 is connected to chipset 1010 via processor interface 1006, and processor 1004 is connected to the chipset via processor interface 1008.

In a particular embodiment, processors 1002 and 1004 are connected via a high-capacity coherent fabric, such as a HyperTransport link, a QuickPath Interconnect, or the like.

Chipset 1010 represents an integrated circuit or group of integrated circuits that manage the data flow between processors 1002 and 1004 and the other elements of information handling system 1000. In a particular embodiment, chipset 1010 represents a pair of integrated circuits, such as a northbridge component and a southbridge component. In another embodiment, some or all of the functions and features of chipset 1010 are integrated with one or more processors 1002 and 1004.

Memory 1020 is connected to chipset 1010 via a memory interface 1022. An example of memory interface 1022 includes a Double Data Rate (DDR) memory channel and memory 1020 represents one or more DDR Dual In-Line Memory Modules (DIMMs). In a particular embodiment, memory interface 1022 represents two or more DDR channels. In another embodiment, one or more of processors 1002 and 1004 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 1020 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 1030 is connected to chipset 1010 via a graphics interface 1032 and provides a video display output 1036 to a video display 1034. An example of a graphics interface 1032 includes a Peripheral Component Interconnect-Express (PCIe) interface and graphics adapter 1030 can include a four-lane (x4) PCIe adapter, an eight-lane (x8) PCIe adapter, a 16-lane (x16) PCIe adapter, or another configuration, as needed or desired. In a particular embodiment, graphics adapter 1030 is provided down on a system printed circuit board (PCB). Video display output 1036 can include a Digital Video Interface (DVI), a High-Definition Multimedia Interface (HDMI), a DisplayPort interface, or the like, and video display 1034 can include a monitor, a smart television, an embedded display such as a laptop computer display, or the like.

NVRAM 1040, disk controller 1050, and I/O interface 1070 are connected to chipset 1010 via an I/O channel 1012. An example of I/O channel 1012 includes one or more point-to-point PCIe links between chipset 1010 and each of NVRAM 1040, disk controller 1050, and I/O interface 1070. Chipset 1010 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a universal serial bus (USB), another interface, or a combination thereof. NVRAM 1040 includes BIOS/EFI module 1042 that stores machine-executable code (BIOS/EFI code) that operates to detect the resources of information handling system 1000, to provide drivers for the resources, to initialize the resources, and to provide common access mechanisms for the resources. The functions and features of BIOS/EFI module 1042 will be further described below.

Disk controller 1050 includes a disk interface 1052 that connects the disc controller to a hard disk drive (HDD) 1054, to ODD 1056, and to disk emulator 1060. An example of disk interface 1052 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 1060 permits SSD 1064 to be connected to information handling system 1000 via an external interface 1062. An example of external interface 1062 includes a USB interface, an institute of electrical and electronics engineers (IEEE) 1394 (Firewire) interface, a proprietary interface, or a combination thereof. Alternatively, SSD 1064 can be disposed within information handling system 1000.

I/O interface 1070 includes a peripheral interface 1072 that connects the I/O interface to add-on resource 1074, to TPM 1076, and to network interface 1080. Peripheral interface 1072 can be the same type of interface as I/O channel 1012 or can be a different type of interface. As such, I/O interface 1070 extends the capacity of I/O channel 1012 when peripheral interface 1072 and the I/O channel are of the same type, and the I/O interface translates information from a format suitable to the I/O channel to a format suitable to the peripheral interface 1072 when they are of a different type. Add-on resource 1074 can include a data storage system, an additional graphics interface, a network interface card (NIC), a sound/video processing card, another add-on resource, or a combination thereof. Add-on resource 1074 can be on a main circuit board, on a separate circuit board, or add-in card disposed within information handling system 1000, a device that is external to the information handling system, or a combination thereof.

Network interface 1080 represents a network communication device disposed within information handling system 1000, on a main circuit board of the information handling system, integrated onto another component such as chipset 1010, in another suitable location, or a combination thereof. Network interface 1080 includes a network channel 1082 that provides an interface to devices that are external to information handling system 1000. In a particular embodiment, network channel 1082 is of a different type than peripheral interface 1072 and network interface 1080 translates information from a format suitable to the peripheral channel to a format suitable to external devices.

In a particular embodiment, network interface 1080 includes a NIC or host bus adapter (HBA), and an example of network channel 1082 includes an InfiniBand channel, a Fibre Channel, a Gigabit Ethernet channel, a proprietary channel architecture, or a combination thereof. In another embodiment, network interface 1080 includes a wireless communication interface, and network channel 1082 includes a Wi-Fi channel, a near-field communication (NFC) channel, a Bluetooth® or Bluetooth-Low-Energy (BLE) channel, a cellular-based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 1082 can be connected to an external network resource (not illustrated). The network resource can include another information handling system, a data storage system, another network, a grid management system, another suitable resource, or a combination thereof.

BMC 1090 is connected to multiple elements of information handling system 1000 via one or more management interface 1092 to provide out-of-band monitoring, maintenance, and control of the elements of the information handling system. As such, BMC 1090 represents a processing device different from processor 1002 and processor 1004, which provides various management functions for information handling system 1000. For example, BMC 1090 may be responsible for power management, cooling management, and the like. The term BMC is often used in the context of server systems, while in a consumer-level device, a BMC may be referred to as an embedded controller. A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 1090 can vary considerably based on the type of information handling system. BMC 1090 can operate in accordance with an Intelligent Platform Management Interface (IPMI). Examples of BMC 1090 include an Integrated Dell® Remote Access Controller (iDRAC).

Management interface 1092 represents one or more out-of-band communication interfaces between BMC 1090 and the elements of information handling system 1000 and can include an Inter-Integrated Circuit (I2C) bus, a System Management Bus (SMBus), a Power Management Bus (PMBUS), a Low Pin Count (LPC) interface, a serial bus such as a USB or a serial peripheral interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 1000, that is apart from the execution of code by processors 1002 and 1004 and procedures that are implemented on the information handling system in response to the executed code.

BMC 1090 operates to monitor and maintain system firmware, such as code stored in BIOS/EFI module 1042, option ROMs for graphics adapter 1030, disk controller 1050, add-on resource 1074, network interface 1080, or other elements of information handling system 1000, as needed or desired. In particular, BMC 1090 includes a network interface 1094 that can be connected to a remote management system to receive firmware updates, as needed or desired. Here, BMC 1090 receives firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 1090 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 1090, an interface defined by the Distributed Management Taskforce (DMTF) (such as a Web Services Management (WSMan) interface, a Management Component Transport Protocol (MCTP) or, a Redfish® interface), various vendor-defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2”boot option, or another protocol or API, as needed or desired.

In a particular embodiment, BMC 1090 is included on a main circuit board (such as a baseboard, a motherboard, or any combination thereof) of information handling system 1000 or is integrated into another element of the information handling system such as chipset 1010, or another suitable element, as needed or desired. As such, BMC 1090 can be part of an integrated circuit or a chipset within information handling system 1000. An example of BMC 1090 includes an iDRAC or the like. BMC 1090 may operate on a separate power plane from other resources in information handling system 1000. Thus BMC 1090 can communicate with the management system via network interface 1094 while the resources of information handling system 1000 are powered off. Here, information can be sent from the management system to BMC 1090 and the information can be stored in a RAM or NVRAM associated with the BMC. Information stored in the RAM may be lost after the power-down of the power plane for BMC 1090, while information stored in the NVRAM may be saved through a power-down/power-up cycle of the power plane for the BMC.

Information handling system 1000 can include additional components and additional busses, not shown for clarity. For example, information handling system 1000 can include multiple processor cores, audio devices, and the like. While a particular arrangement of bus technologies and interconnections is illustrated for the purpose of example, one of skill will appreciate that the techniques disclosed herein are applicable to other system architectures. Information handling system 1000 can include multiple central processing units (CPUs) and redundant bus controllers. One or more components can be integrated together. Information handling system 1000 can include additional buses and bus protocols, for example, I²C and the like. Additional components of information handling system 1000 can include one or more storage devices that can store machine-executable code, one or more communications ports for communicating with external devices, and various input and output (I/O) devices, such as a keyboard, a mouse, and a video display.

For purposes of this disclosure, information handling system 1000 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 1000 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 1000 can include processing resources for executing machine-executable code, such as processor 1002, a programmable logic array (PLA), an embedded device such as a System-on-a-Chip (SoC), or other control logic hardware. Information handling system 1000 can also include one or more computer-readable media for storing machine-executable code, such as software or data.

Although FIG. 9 shows example blocks of method 900 in some implementations, method 900 may include additional blocks, fewer blocks, different blocks, or differently arranged blocks than those depicted in FIG. 9. Those skilled in the art will understand that the principles presented herein may be implemented in any suitably arranged processing system. Additionally, or alternatively, two or more of the blocks of method 900 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. An information handling system, comprising:
a leak detection sensor that includes:
an insulator with a first surface and a second surface;
a first conductive ink formed in a first conductive pattern on the first surface; and
a second conductive ink formed in a second conductive pattern on the second surface; and
a processor coupled to the leak detection sensor, the processor configured to:
measure a resistance change associated with the first conductive ink and the second conductive ink; and
in response to a determination that the resistance change is below a threshold,
transmit a signal indicating that a leak is detected.

2. The information handling system of claim 1, wherein the leak detection sensor is vacuum-formed to a chassis.

3. The information handling system of claim 2, wherein the chassis is a tray structure.

4. The information handling system of claim 1, wherein the first conductive ink and the second conductive ink are conductive polymer inks.

5. The information handling system of claim 4, wherein the first conductive ink and the second conductive ink are impregnated with rubber.

6. The information handling system of claim 1, wherein the insulator includes a first set of holes on the first surface and a second set of holes on the second surface.

7. The information handling system of claim 1, wherein the insulator includes a polymer substrate.

8. The information handling system of claim 1, wherein the insulator includes a hole.

9. The information handling system of claim 1, wherein the insulator is perforated.

10. An information handling system, comprising:
a leak detection sensor that includes:
an insulating layer; and
a conductive ink formed in a conductive pattern on a surface of the insulating layer,
wherein the conductive pattern includes a first trace and a second trace; and
a processor coupled to the leak detection sensor, the processor configured to:
measure a resistance change between the first trace and the second trace; and
in response to a determination that the resistance change is below a threshold,
transmit a signal indicating that a leak is detected.

11. The information handling system of claim 10, wherein the leak detection sensor is sprayed on a surface of a chassis.

12. The information handling system of claim 10, wherein the conductive ink is a conductive polymer ink.

13. The information handling system of claim 12, wherein the conductive ink is impregnated with rubber.

14. The information handling system of claim 10, wherein the first trace and the second trace are interdigitated in opposition of each other.

15. The information handling system of claim 10, wherein the leak detection sensor includes a layer of insulating paint on the conductive ink.

16. The information handling system of claim 10, wherein the insulating layer includes a polymer substrate.

17. A method comprising:
measuring an electrical change associated with a first trace and a second trace of a leak detector, wherein both of the first trace and the second trace include a conductive material over an insulating layer of the leak detector; and
in response to determining that the electrical change is below a threshold, transmitting a signal indicating that a leak is detected around the first trace and the second trace disposed over the insulating layer of the leak detector.

18. The method of claim 17, wherein the electrical change is a resistance change.

19. The method of claim 17, wherein the electrical change is a capacitance change.

20. The method of claim 17, further comprising in response to determining that the electrical change is above the threshold, continue monitoring for the leak.
